(19) United States
(12) Patent Application Publication
(10) Pub. No.: US 2013/0286382 A1
(43) Pub. Date: Oct. 31, 2013

(54) LIGHT GUIDE PLATE HOLDER AND LIGHT GUIDE PLATE TESTING SYSTEM USING SAME

(71) Applicant: PO-CHOU CHEN, Tu-Cheng (TW)

(72) Inventor: PO-CHOU CHEN, Tu-Cheng (TW)

(73) Assignee: HON HAI PRECISION INDUSTRY CO., LTD., Tu-Cheng (TW)

(21) Appl. No.: 13/492,930

(22) Filed: Jun. 11, 2012

(30) Foreign Application Priority Data
Apr. 25, 2012 (TW) 101114687

(51) Int. Cl. F21V 8/00; G01N 21/01

(52) U.S. Cl. 356/73.1; 362/615

(57) ABSTRACT

A light guide plate holder includes a base, a partitioning plate, and two clamping blocks. The base includes a bottom wall and two side walls extending from opposite ends of the bottom wall, the bottom wall and the two side walls cooperatively forming a receiving space. The partitioning plate is positioned on the bottom wall in the receiving space, the partitioning plate partitioning the receiving space into two sub-spaces. The clamping blocks are detachably received in the respective sub-spaces, and each of the clamping blocks is configured for cooperating with the partitioning plate to clamp a light guide plate therebetween. A light guide plate testing system using the light guide plate holder is also provided. The testing system is used for testing microstructures on a light incident surface of a light guide plate.

### BACKGROUND

1. Technical Field

The present disclosure relates to a light guide plate holder and a light guide plate testing system using the holder.

2. Description of Related Art

Light guide plates have been thinner and thinner to couple with point light sources, such as LEDs. When the number of the LEDs is reduced for cost consideration, see FIG. 3, the light incident surface 220 of the light guide plate 200 needs microstructures 210 to diffuse the light. Various shapes such as R-cut or V-cut can be used as the microstructures 210, and the microstructures 210 can be formed integrally with the light guide plate 200.

In testing the light guide plate 200, as the microstructures 210 may be too small, a testing tool such as a microscope has to be used for testing the molding of the microstructures 210. However, the light guide plate 200 may be too thin to be held by hand. Furthermore, when two or more light guide plates 200 are molded at a mold, the two or more light guide plates 200 are difficult to compare.

What is needed, therefore, is a light guide plate holder and a light guide plate testing system using the holder, which can overcome the above shortcomings

### BRIEF DESCRIPTION OF THE DRAWINGS

Many aspects of the present light guide plate holder and light guide plate testing system can be better understood with reference to the following drawings. The components in the drawings are not necessarily drawn to scale, the emphasis instead being placed upon clearly illustrating the principles of the present light guide plate holder and light guide plate testing system. Moreover, in the drawings, like reference numerals designate corresponding parts throughout the several views.

FIG. 1 is a schematic isometric view of a light guide plate holder in accordance with an embodiment.

FIG. 2 is an isometric view of a light guide plate testing system in testing light guide plates in accordance with an embodiment.

FIG. 3 is an isometric view of a conventional light guide plate.

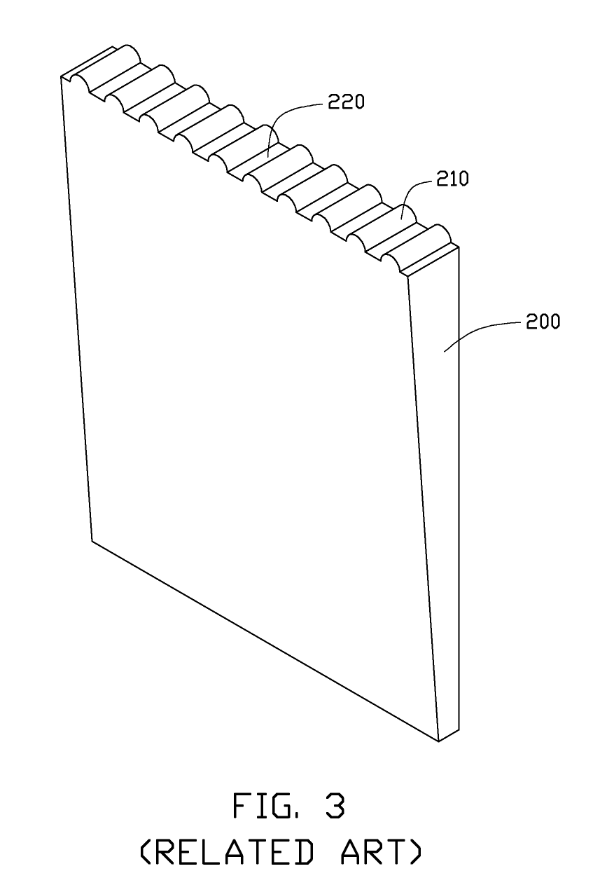

### DETAILED DESCRIPTION

Embodiments of the present light guide plate holder and light guide plate testing system will now be described in detail below and with reference to the drawings.

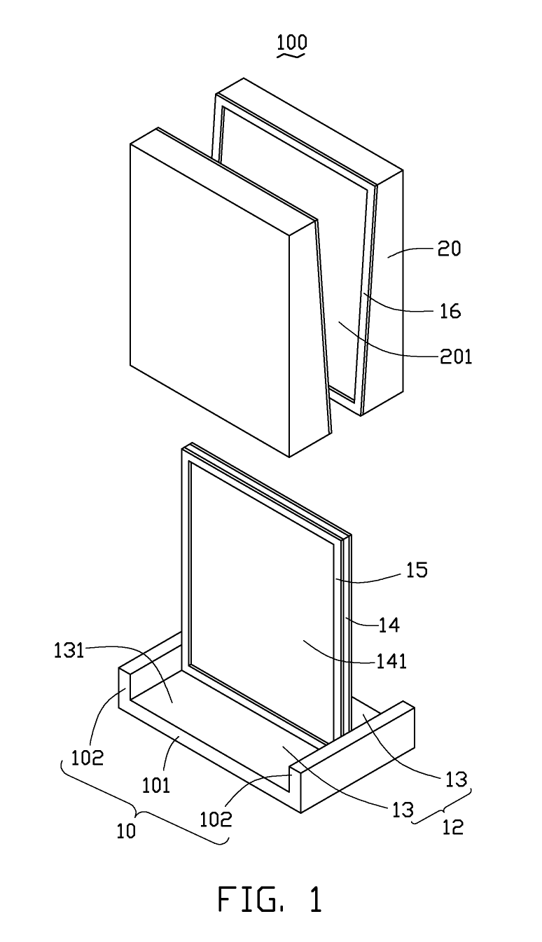

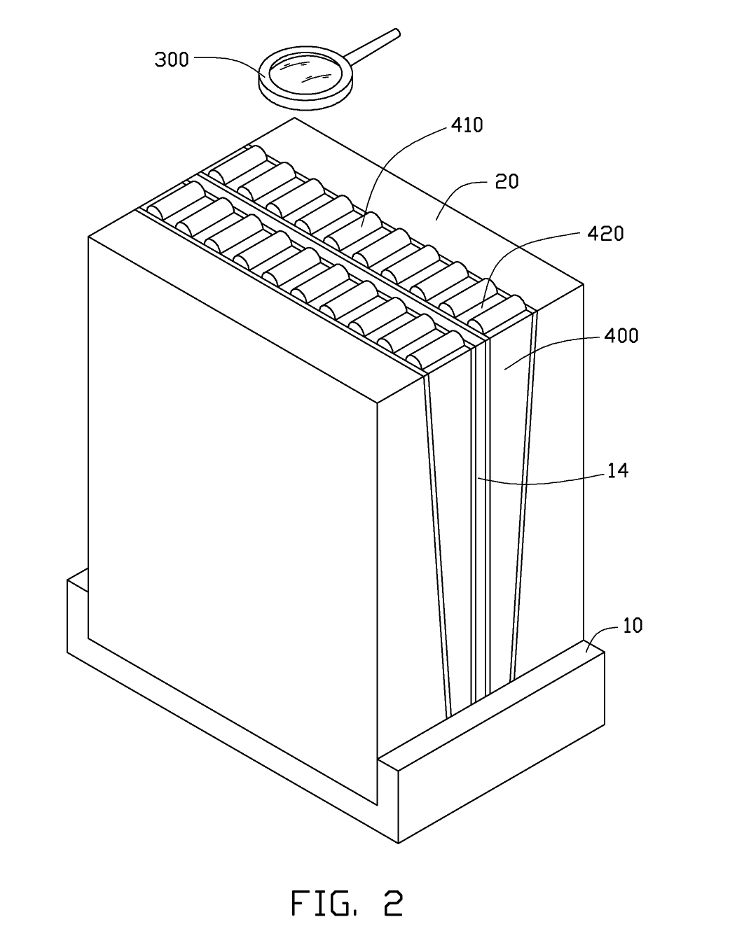

Referring to FIGS. 1 and 2, an exemplary light guide plate holder 100 includes a base 10, a partitioning plate 14, and two clamping blocks 20.

The base 10 includes a bottom wall 101 and two side walls 102 extending from opposite ends of the bottom wall 101. The bottom wall 101 and the two side walls 102 cooperatively forming a receiving space 12 exposed to the other opposite ends of the bottom wall 101.

The partitioning plate 14 is positioned in the receiving space 12 and partitions the receiving space 12 into two sub-space 13, with each one of the sub-space 13 exposed to one end. Each of the sub-space 13 has a flat top surface 131 for facilitating a light guide plate 400 and one of the clamping blocks 20 entering into the sub-space 13. The partitioning plate 14 and the clamping blocks 20 cooperatively hold two light guide plates 400 in the respective sub-spaces 13.

The partitioning plate 14 can be integrally formed in the receiving space 12, or alternatively be mounted and fixed in the receiving space 12. Preferably, the partitioning plate 14 is positioned at a middle position in the receiving space 12. The partitioning plate 14 is substantially perpendicular to the side walls 102. The partitioning plate 14 includes opposite side surfaces 141 facing toward the respective light guide plates 400, and two first elastic layers 15 attached to the respective side surfaces 141. Each of the first elastic layers 15 is in a hollow rectangular shape. In the present embodiment, each of the first elastic layers 15 surrounds a periphery of a corresponding one of the side surfaces 141 of the partitioning plate 14. The first elastic layers 15 are configured as spacers for resiliently contacting the respective light guide plates 400, such that damages to corresponding surfaces of the light guide plates 400 can be avoided.

Each of the clamping blocks 20 has a main surface 201 facing toward one of the light guide plates 400, and a second elastic layer 16 attached to each of the main surfaces 201. Each of the second elastic layers 16 is also in a hollow rectangular shape. In the present embodiment, each of the second elastic layers 16 surrounds a periphery of a corresponding one of the main surfaces 201 of the clamping blocks 20. The second elastic layers 16 are configured as spacers for resiliently contacting the respective light guide plates 400, such that damages to corresponding surfaces of the light guide plates 400 can be avoided.

The area of each of the side surfaces 141 and main surfaces 201 is substantially equal in size to the area of the corresponding one of the surfaces of the light guide plates 400. A surrounding area of each of the first and second elastic layers 15, 16 is also substantially equal in size to an area of the corresponding one of the surfaces of the light guide plates 400. The first and second elastic layers 15, 16 can be adhered to the side surfaces 141 and the main surfaces 201, or alternatively, be inserted into slots (not shown) formed in the side surfaces 141 and the main surfaces 201.

When the light guide plates 400 are received in the respective sub-space 13, the clamping blocks 20 move toward the light guide plates 200 to clamp the respective light guide plates 400 in position. The light guide plates 400 abut on the partitioning plate 14 and the clamping blocks 20 by contacting the first and second elastic layers 15, 16. The light incident surfaces 420 of the light guide plates 400 face upwards, i.e., the microstructures 410 of the light incident surfaces 420 face upwards. The light guide plates 400 are maintained straightforward. In the present embodiment, the partitioning plate 14 is rectangular, and each of the clamping blocks 20 is in a shape corresponding to the shape of the corresponding one of the light guide plates 400, such that the light guide plates 400 are held compactly by the partitioning plate 14 and the clamping blocks 20 (see FIG. 2).

It is understood that when only one light guide plate 400 is to be held, only one clamping block 20 is needed.

The light guide plate holder 100 can be directly used in a light guide plate testing system which may further includes a testing tool such as a microscope 300 to test the microstructures 410 of the light incident surfaces 420 of the light guide plates 400.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A light guide plate holder, comprising:
a base comprising a bottom wall and two side walls extending from opposite ends of the bottom wall, the bottom wall and the two side walls cooperatively forming a receiving space;
a partitioning plate positioned on the bottom wall in the receiving space, the partitioning plate partitioning the receiving space into two sub-spaces; and
two clamping blocks detachably received in the respective sub-spaces, each of the clamping blocks configured for cooperating with the partitioning plate to clamp a light guide plate therebetween.

2. The light guide plate holder of claim 1, wherein the bottom wall includes a flat top surface exposed in each of the sub-spaces.

3. The light guide plate holder of claim 1, wherein the partitioning plate comprises two first elastic layers formed on opposite side surfaces of the partitioning plate, and each of the first elastic layers is configured for resiliently contacting the corresponding light guide plate.

4. The light guide plate holder of claim 3, wherein each of the clamping blocks has a main surface facing toward the partitioning plate, and a second elastic layer formed on each of the main surfaces, and configured for resiliently contacting the corresponding light guide plate.

5. The light guide plate holder of claim 1, wherein the partitioning plate is substantially perpendicular to the side walls.

6. A light guide plate testing system for testing microstructures on a light incident surface of a light guide plate, the testing system comprising:
a light guide plate holder, comprising:
a base comprising a bottom wall and two side walls extending from opposite ends of the bottom wall, the bottom wall and the two side walls cooperatively forming a receiving space;
a partitioning plate positioned on the bottom wall in the receiving space, the partitioning plate separating the receiving space into two sub-spaces; and
two clamping blocks detachably received in the respective sub-spaces, each of the clamping blocks configured for cooperating with the partitioning plate to clamp a light guide plate therebetween; and
a testing tool configured for testing the microstructures on the light incident surface of the light guide plate.

7. The light guide plate testing system of claim 6, wherein the bottom wall includes a flat top surface exposed in each of the sub-spaces.

8. The light guide plate testing system of claim 6, wherein the partitioning plate comprises two first elastic layers formed on opposite side surfaces of the partitioning plate, and each of the first elastic layers is configured for resiliently contacting the corresponding light guide plate.

9. The light guide plate testing system of claim 8, wherein each of the clamping blocks has a main surface facing toward the partitioning plate, and a second elastic layer formed on each of the main surfaces, and configured for resiliently contacting the corresponding light guide plate.

10. The light guide plate testing system of claim 6, wherein the partitioning plate is substantially perpendicular to the side walls.

11. A light guide plate holder, comprising:
a base comprising a bottom wall and two side walls extending from opposite ends of the bottom wall, the bottom wall and the two side walls cooperatively forming a receiving space;
a partitioning plate positioned on the bottom wall in the receiving space, the partitioning plate partitioning the receiving space into two sub-spaces; and
at least one clamping block detachably received in one of the sub-spaces, the at least one clamping block configured for cooperating with the partitioning plate to clamp at least one light guide plate therebetween in the corresponding one of the sub-spaces.
